(19) United States
(12) Patent Application Publication
(10) Pub. No.: US 2008/0104064 A1
(43) Pub. Date: May 1, 2008

(54) Electrospray Ionization Mass Spectrometer Interface

(76) Inventor: Gangqiang Li, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/548,218

(22) Filed: Oct. 10, 2006

(51) Int. Cl. G06F 17/30

(52) U.S. Cl. 707/6; 250/282; 324/158.1

(57) ABSTRACT

The invention provides a mass spectrometry interface for collecting ions and directing a drying gas. The mass spectrometer interface may be used independently or in combination with an ion source and a mass spectrometry system. The mass spectrometer interface, includes a body portion having a first open end; and a tip portion in contact with the body portion having a second open end and a wall with an aperture for receiving ion, the wall having a cross-sectional area that tapers from the first open end of the body portion toward the second open end of the tip portion, wherein the mass spectrometer interface may direct a gas from the first open end of the body portion toward the second open end of the tip portion and the aperture in the wall of the tip portion may receive ions for drying by the gas.

The invention also provides methods for ion collection and drying. The method for collecting and drying molecules, includes directing ions through an aperture of a closed mass spectrometry interface; and drying the molecules using a drying gas.

### BACKGROUND

Atmospheric pressure ionization methods have been widely used in mass spectrometry applications because they can be utilized for a wide range of chemical and biological samples. Ionization at atmospheric pressure has advantages such as simplicity and accessibility during the operation. However, since a mass spectrometer is operated substantially at low pressure (10⁻⁴ to 10⁻⁹ Torr), the ions produced at atmospheric pressure need to be transmitted into vacuum via a mass spectrometer interface. A large portion of ions generated at atmospheric pressure are lost during the transmission process. Therefore, the type of interface used is often important since it affects the sensitivity, stability and reproducibility of a sample detection.

Electrospray ionization (ESI) is the most common atmospheric pressure ionization (API) source used today. ESI often uses a capillary to deliver sample solution to a metal (or metalized) needle (spray tip) at a location near the mass spectrometer interface. By applying an electric field between the needle and interface, charge droplets are generated as a continuous spray. In certain embodiments, an interface has been constructed using one or more conductive conical orifices arranged concentrically around the capillary end. The central axis of this orifice is generally oriented perpendicular or in an orthogonal arrangement to the spray tip. While spray is generated between the needle and interface, a heated drying gas stream (usually nitrogen gas at 3 to 10 liters/min.) is sent through the gap between the cone orifices. By colliding with drying gas molecules, the charged droplets in the spray undergo a desolvation process and become single or multiply charged ions. These ions continue to propogate in vacuum via the inner orifice and are analyzed by the mass spectrometer. Collisional desolvation (collision of droplets and heated gas to produce ions) is an important process for determining ionization and ion collection efficiency and, therefore, sample detection sensitivity. Other interfaces exist for efficiently collecting ions. The problem with most of these interfaces concerns their less than efficient and effective ion collection when a drying gas is employed to dry the ions. In many cases the drying gas is actually directed opposite in direction to the flow of ions. This impacts the overall ions that are collected.

In a conventional electrospray environment and interface the desolvation process occurs in a common open environment. Drying gas flow has a considerable influence also on spray formation as well as collection. A problematic side effect of this is the fact that in certain cases the drying gas can actually heat the spray tip and solution before the spray is generated. This causes less than ideal conditions for formation and collection of ions. In addition, such conditions can also cause undesirable change in chemical composition of an analyte solution.

Lastly, the drying gas in certain instances can also cause turbulence near the spray tip so the spray becomes unstable. The instability under the influence of drying gas is more significant in a low flow spray ion source. Especially when spray is not gas assisted. These and other problems are addressed by the present invention.

### SUMMARY OF THE INVENTION

The invention provides a mass spectrometry system, comprising: an ion source for producing ions; a capillary adjacent to the ion source for receiving ions, and a mass spectrometer interface disposed between the ion source and the capillary. The mass spectrometer interface, comprises: a body portion having a first open end; and a tip portion in contact with the body portion having a second open end and a wall with an aperture for receiving ions, the wall having a cross-sectional area that tapers from the first open end of the body portion toward the second open end of the tip portion, wherein the mass spectrometer interface may direct a gas from the first open end of the body portion toward the second open end of the tip portion and the aperture in the wall of the tip portion may receive ions for drying by the gas.

The invention also provides an ion source for a mass spectrometry system, comprising a source of ions; a capillary for receiving ions; and a mass spectrometer interface disposed between the source of ions and the capillary. The mass spectrometer interface, comprises a body portion having a first open end; and a tip portion in contact with the body portion having a second open end and a wall with an aperture for receiving ion, the wall having a cross-sectional area that tapers from the first open end toward the body portion,wherein the mass spectrometer interface may direct a gas from the first open end of the body portion toward the second open end of the tip portion and the aperture in the tip portion may receive ions for drying by the gas.

The invention also provides an independent mass spectrometer interface. The mass spectrometer interface, comprises a body portion having a first open end; and a tip portion in contact with the body portion having a second open end and a wall with an aperture for receiving ion, the wall having a cross-sectional area that tapers from the first open end of the body portion toward the second open end of the tip portion, wherein the mass spectrometer interface may direct a gas from the first open end of the body portion toward the second open end of the tip portion and the aperture in the wall of the tip portion may receive ions for drying by the gas.

The invention also provides a method of collecting and drying molecules, comprising directing ions through an aperture of a closed mass spectrometry interface; and drying the molecules using a drying gas.

### BRIEF DESCRIPTION OF THE FIGURES

The invention is described in detail below with reference to the following figures:

FIG. 1 shows a general block diagram of the present invention.

FIG. 2 shows a perspective view of a first embodiment of the present invention.

FIG. 3 shows a second embodiment of the present invention.

FIG. 4 shows a third embodiment of the present invention that is similar to the second embodiment, but an exhaust port has been added.

FIG. 5 shows a fourth embodiment of the present invention.

### DETAILED DESCRIPTION OF THE INVENTION

Before describing the invention in detail, it must be noted that, as used in this specification and the appended claims, the singular forms “a,” “an,” and “the” include plural referents unless the context clearly dictates otherwise. Thus, for example, reference to “a housing” may include more than one “housing”. Reference to “an ion source” may include more than one “ion sources”.

In describing and claiming the present invention, the following terminology will be used in accordance with the definitions set out below.

The term “adjacent” means near, next to, or adjoining.

The term “body portion” refers to the portion of the collection conduit, capillary or device used for ejecting ions.

The term “capillary” refers to a conduit, tube, pipe or similar type structure that may be used to collect ions. The structure may comprise any number of shapes and sizes and diameters. Other shapes, sizes and designs may also be possible.

The term “closed” refers to any structure material, housing or enclosure that substantially surround the ion spray and/or drying gas.

The term “housing” refers to any structure, casing or enclosure that may be used for enclosing electrospray ions and drying gas.

The term “ion source” refers to any type of ion sources known in the art for producing a spray of ions. This may include high and low flow sources. Some sources may include and not be limited to electrospray ionization sources (ESI), chemical ionization sources and/or nanospray ionization sources.

The term “source of ions” refers to any device, source, components or parts of such devices that may be employed to produce or create ions.

The term “mass spectrometer interface” refers to any structure, design or enclosure which is used to collect ions and direct drying gas.

The term “mass spectrometer” refers to any device, structure or instrument used for detecting and measuring ions based on a mass to charge ratio.

The term “spray chamber” is used as commonly employed in the art. The term refers to any chamber and housing used to enclose the ions source and/or source of ion spray.

The term “substantially similar in shape” means similar in border or outside design. Having a similar body portion, tip portion, both body and tip portion or exterior surface shape. Closely matching the shape of the enclosed component, structure or surface.

The term “tip portion” refers to the portion of the conduit, capillary or device used for receiving or collecting ions.

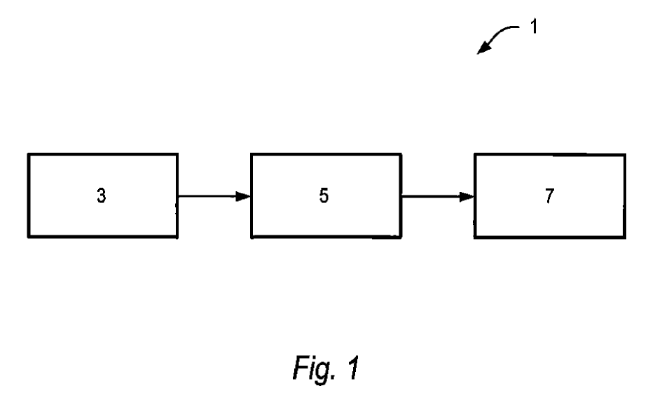

FIG. 1 shows a general block diagram of the present invention. Referring to FIG. 1, the mass spectrometry system 1 of the present invention comprises an ion source 3, a mass spectrometer interface 5 and a detector 7. The mass spectrometer interface 5 is disposed between the ion source 3 and the detector 7.

The ion source 3 may comprise any number of different ion sources known in the art for producing and spraying ions. For instance, the ion source 3 may comprise an electrospray ion source (ESI), or a nanospray or other low flow ion source device. Other devices known in the art that functional spray or direct a stream of directed ions may also be employed with the present invention. These devices may or may not be at atmospheric pressure. Other spray sources may comprise and not be limited to gas assisted spray, gas-free spray, micro-machined spray tips and spray tips made on a chip. It should also be noted that the ion source 3 may be arranged in any number of positions and locations relative to the mass spectrometer interface 5.

The mass spectrometer interface 5 may comprise a separate component or may be integrated with the ion source 3 or the detector 7. Details regarding the mass spectrometer interface 5 will be provided below. The mass spectrometer interface 5 may comprise any number of shapes, sizes and locations.

The detector 7 is disposed downstream from the mass spectrometer interface 5. The detector 7 may comprise any number of detectors known in the art. For instance, the detector 7 may comprise a time-of-flight (TOF) detector or a Q-TOF detector, or any other similar type detectors.

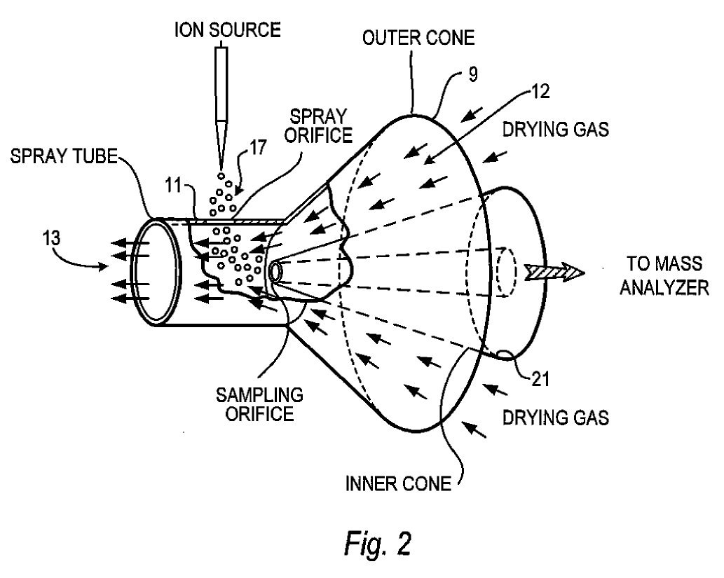

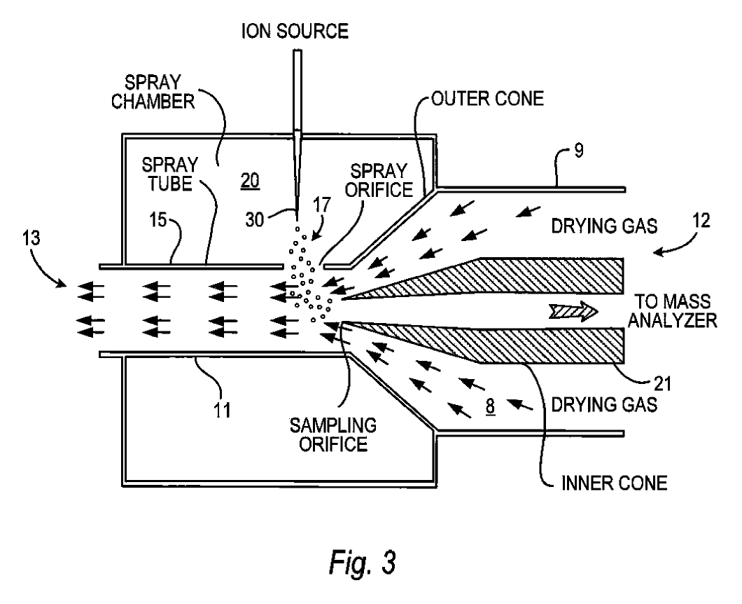

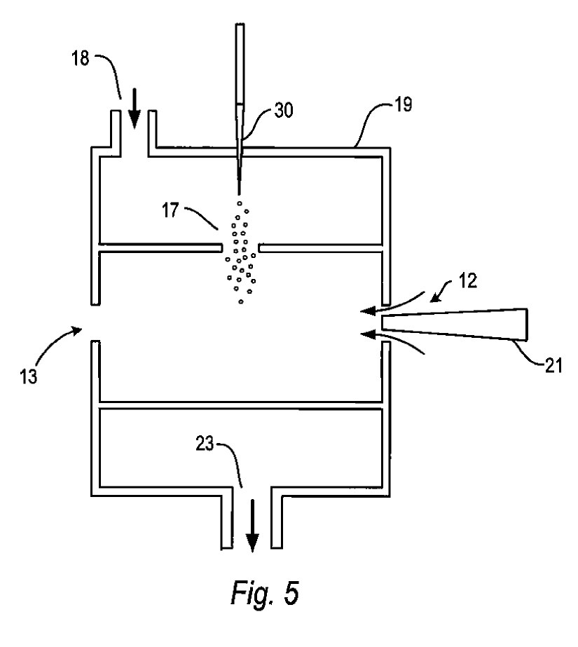

Referring now to FIGS. 3-5, the mass spectrometer interface 5 will now be described in additional detail. The mass spectrometer interface 5 comprises a body portion 9 and a tip portion 11. The body portion 9 may be contacted or connected to the tip portion 11. This is not a requirement of the invention and in certain cases the two components may not be contacting or connected. For instance, the mass spectrometer interface 5 may comprise a single housing having an aperture 17 and a first open end 12 (See FIG. 5). The body portion 9 includes a first open end 12. The body portion 9 is defined for directing ions toward a capillary 21 that leads to the detector 7. The tip portion 11 has a second open end 13 that is generally positioned opposite the first open end 12 of the body portion 9. The first open end 12 can range from about 10 to 20 millimeters (mm). However, other sizes are also possible. The invention should not be interpreted to be limited to these ranges. The second open end 13 can range in size from about 4 to 8 mm. However, this is not a requirement and the invention should not be interpreted to be limited to these dimensions. The tip portion 11 comprises a wall 15 that comprises one or more apertures 17 for collecting ions. The tip portion 11 may comprise stainless steel or similar type materials. A variety of materials may be employed. However, the material should not be magnetic or magnetic in nature. The aperture 17 in the wall 15 of the tip portion 11 is generally positioned adjacent to the source of ions 18 or ion source 3. The aperture 17 can range from around 1-5 millimeters (mm) or typically 2-3 mm in diameter. However, other sizes are possible and the invention should not be interpreted to be limited to the ranges. A drying gas is introduced through the first open end 12 of the body portion 9 of the present invention. Ions are typically sprayed form the source of ions 18 toward the wall of the tip portion 15 and collected through the aperture 17. The invention provides a mass spectrometer interface 5 that in most cases should produce a more stable spray ionization. The stability of the spray and the efficiency in desolvation is more pronounced for low flow. This is especially true when the spray is non-gas assisted. As a result this should result in overall increased instrument improvement and sensitivity. In addition, the present invention provides for flexibility for arranging various devices relative to the mass spectrometer interface 5 so that ionization conditions can be optimized. As discussed, the mass spectrometer interface 5 is designed to provide a separate passage and exit passage for the drying gas (second open end 13). By isolating the spray process and desolvation process, drying gas no longer has influence on the spray formation. It should be noted that in certain embodiments, the shape or structure of the mass spectrometer interface 5 may be substantially similar to the shape or structure of the capillary 21 (See FIGS. 2-5). Similarity in structure and design is not a requirement of the invention. However, in certain cases such substantial similarity may provide for advantageous and efficient directing of gas flow.

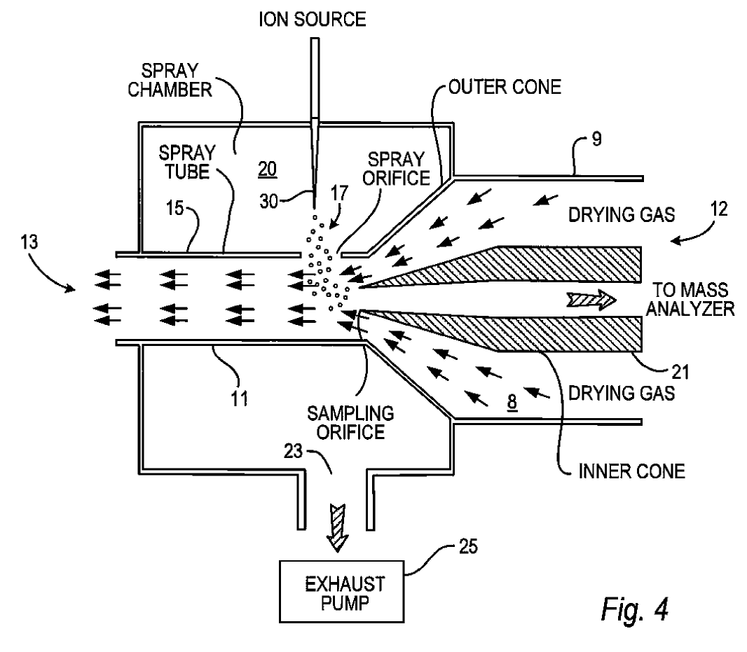

FIGS. 3 and 4 show second and third embodiments of the present invention. These embodiments are similar to the embodiment shown in FIG. 2. However, spray chamber 20 is now employed. Spray chamber 20 may be at atmospheric pressure (760 Torr) or it may be above or below atmospheric pressure. For instance, the range may be 500-1000 Torr. Mass spectrometer interface 5 extends across the spray chamber 20. This is not a requirement of the invention. For instance, it can be imagined in certain embodiments that the mass spectrometer interface 5 may extend only across a portion of the spray chamber 20. FIG. 4 shows a similar embodiment to FIG. 3, but an exhaust port 23 is present. The exhaust port 23 is generally connected or in communication with and exhaust pump 25. The exhaust port 23 and the exhaust pump 25 may be any number of positions and locations in the spray chamber 20. Other embodiments, shapes, sizes and number of pumps and ports may also be possible.

FIG. 5 shows a further embodiment of the present invention. In this embodiment of the invention the mass spectrometer interface 5 may comprise a housing 19. The housing 19 comprises a first open end 12 and a second open end 13. The shapes, sizes and location of the first open end 12 and the second open end 13 may vary. For instance, the first open end 12 may be quite large, while the second open end 13 may be as small as an aperture. The housing 19 may be in contact with the capillary 21. In certain embodiments it may comprises a portion of the ion source 3 and/or capillary 21. This is not a requirement of the invention.

Having described the apparatus of the invention, a description of the method of operation is now in order.

Referring to FIGS. 2-5, the method of collecting and drying ions, comprises directing ions through the aperture 17 of a mass spectrometry interface 5 and drying the ions using a drying gas. Typically, the method begins by first introducing molecules into the ion source 3. The ion source then sprays a liquid to form small droplets. The ion source may comprise a nebulizer and nebulizer tip 30. The nebulizer tip is set at potential while the capillary 21 is set at ground. A voltage differential is established at the nebulizer tip 21. Ions and charge molecules are then formed by spraying the analyte through the nebulizer tip 30. After the ions are formed they pass through the aperture 17 where they are then collected in the mass spectrometer interface 5. A drying gas such as nitrogen is then typically directed from the first open end 12 of the mass spectrometer interface 12 toward the second open end 13 of the mass spectrometer interface. In the diagram this is from the body portion 9 toward the tip portion 11. The drying gas then dries the ions.

This is accomplished largely by a desolvation process combined with gas phase ions being formed. The ions are then collected by the capillary 21 and sent to the mass spectrometer and/or detector for analysis. During this process, the drying gas is confined within the mass spectrometer interface 5. Gas molecules that may escape through the aperture 17 may be insignificant. Therefore, drying gas does not interfere with the spray formation and undesirable heating of the nebulizer tip 30 by gas is minimized. The mass spectrometer interface 5 generally utilizes laminar heating gas flow and this also avoids the heating of the nebulizer tip 30. This stabilizes the desolvation process. The excess gas is directed toward the second open end 13, where it exits the mass spectrometer interface 5. The ions that are

We claim:

1. A mass spectrometer interface, comprising:
(a) a body portion having a first open end; and
(b) a tip portion in contact with the body portion having a second open end and a wall with an aperture for receiving ion, the wall having a cross-sectional area that tapers from the first open end of the body portion toward the second open end of the tip portion,
wherein the mass spectrometer interface may direct a gas from the first open end of the body portion toward the second open end of the tip portion and the aperture in the wall of the tip portion may receive ions for drying by the gas.

2. A mass spectrometry system, comprising:
(a) an ion source for producing ions;
(b) a capillary adjacent to the ion source for receiving ions, and
(c) a mass spectrometer interface disposed between the ion source and the capillary.

3. A mass spectrometry system as recited in claim 2, wherein the mass spectrometer interface comprises a housing.

4. A mass spectrometry system as recited in claim 3, wherein the housing comprises and aperture for receiving ions.

5. A mass spectrometry system as recited in claim 2, further comprising a spray chamber.

6. A mass spectrometry system as recited in claim 5, wherein the mass spectrometer interface is disposed in the spray chamber.

7. A mass spectrometry system as recited in claim 6, wherein the mass spectrometer interface extends across the spray chamber.

8. A mass spectrometry system as recited in claim 4, wherein the housing comprises a body portion and a tip portion.

9. A mass spectrometry system as recited in claim 4, wherein the housing comprises a housing wall having a defined cross-sectional area and the capillary has a capillary wall with a defined cross sectional area and the housing wall is substantially similar in shape to the capillary wall.

10. A mass spectrometry system as recited in claim 4, wherein the mass spectrometer interface, comprises:
(a) a body portion having a first open end; and
(b) a tip portion in contact with the body portion having a second open end and a wall with an aperture for receiving ion, the wall having a cross-sectional area that tapers from the first open end toward the body portion,
wherein the mass spectrometer interface may direct a gas from the first open end of the body portion toward the second open end of the tip portion and the aperture in the tip portion may receive ions for drying by the gas.

11. An ion source for a mass spectrometry system, comprising:
(a) a source of ions;
(b) a capillary for receiving ions; and
(c) a mass spectrometer interface disposed between the source of ions and the capillary.

12. An ion source as recited in claim 11, wherein the mass spectrometer interface comprises a housing.

13. An ion source as recited in claim 12, wherein the housing comprises an aperture for receiving ions.

14. An ion source as recited in claim 12, further comprising a spray chamber.

15. An ion source as recited in claim 14, wherein the mass spectrometer interface is disposed in the spray chamber.

16. An ion source as recited in claim 15, wherein the mass spectrometer interface extends across the spray chamber.

17. An ion source as recited in claim 12, wherein the housing comprises a body portion and a tip portion.

18. An ion source as recited in claim 12, wherein the housing comprises a housing wall having a defined cross-sectional area and the capillary has a capillary wall with a defined cross sectional area and the housing wall is substantially similar in shape to the capillary wall.

19. An ion source as recited in claim 12, wherein the mass spectrometer interface, comprises:
(a) a body portion having a first open end; and
(b) a tip portion in contact with the body portion having a second open end and a wall with an aperture for receiving ion, the wall having a cross-sectional area that tapers from the first open end toward the body portion,
wherein the mass spectrometer interface may direct a gas from the first open end of the body portion toward the second open end of the tip portion and the aperture in the tip portion may receive ions for drying by the gas.

20. A method of collecting and drying molecules, comprising:
(a) directing ions through an aperture of a closed mass spectrometry interface; and
(b) drying the molecules using a drying gas.
